(19) United States
(12) Patent Application Publication
(10) Pub. No.: US 2010/0166365 A1
(43) Pub. Date: Jul. 1, 2010

(54) APPARATUS FOR COLLECTION AND TRASMISSION OF LIGHT

(76) Inventor: Bengt Steneby, Partille (SE)

Correspondence Address: HOLLAND & HART, LLP, P.O BOX 8749, DENVER, CO, 80201, US

(21) Appl. No.: 12/451,591

(22) PCT Filed: May 22, 2008
(86) PCT No.: PCT/SE2008/050605

§ 371 Date: Mar. 17, 2010

(30) Foreign Application Priority Data
Jun. 22, 2007 (SE) 0701232-1

(51) Int. Cl. G02B 6/26

(52) U.S. Cl. 385/15

(57) ABSTRACT

An apparatus is presented for capture and transfer of sunlight. The apparatus comprises a light capturing section, an optical fibre which comprises a first end, a second end and a light transferring section arranged between the ends, which light transferring section along its entire length has an essentially constant crosssectional area and which first end is connected to the light capturing section, and a body with essentially the same refractive index as the light transferring section. The second end of the optical fibre is connected to a first end of the body, the second end of the body, which is opposite the first end of the body, has a larger crosssectional area than the light transferring section and first and second ends of the body are essentially plane parallel.

### TECHNICAL FIELD

The present invention pertains to the field of sunlight collectors in order to conduct sunlight through optical fibres for lighting purposes and more specifically to improving the area where light leaves the optical fibre.

### BACKGROUND

As a rule, light compressing techniques, comprising light collecting lenses and/or light collecting mirrors which deflect or reflect the light towards one focal point where the light is led further into the optical fibre, are used at the capture of sunlight in order to conduct the light further through optical fibre. This has been described in the Patent Application with number: PCT/SE2005/001636, PCT/SE03/00662.

At the focal point a great deal of light radiation energy is transmitted which can require devices for removing undesired wavelengths from the light, which has been described in the Swedish Patent Application with number 0700345-2.

The light is led further through the fibre towards the end of the fibre where the light passes out in for example a fitting for lighting purposes in buildings or in other places. When the light passes from the core of the fibre with a higher optical refractive index out in the air with its lower refractive index, then a small amount of light is reflected back in the border layer. It is of significance to have as good efficiency as is technically and economically reasonable so a minimisation of the back reflection has a significance. Since there is a great deal of radiation energy which passes through a small cross-sectional area, disturbances of the light transmission can result in significant warming. If for example a light absorbing contaminant ends up on the end of the fibre, the fibre itself can suffer from the heat which can propagate as fibre degenerating melting of the fibre against the direction of the light radiation, which can last as long as the light energy from the sun continues to shine into the fibre. The fibre exposes its inner core exactly at the end of the fibre which is why this is a particularly sensitive area. Fibres made of PMMA are sensitive to heating but also fibre made from glass fibre or quartz can suffer, since especially the cladding of the optical fibres can be more heat sensitive than the core of the fibre itself. As many optical fibres are collected in one ending, glue which glues together the fibres in the ending can be more heat sensitive than the core of the fibre itself.

The U.S. Pat. No. 4,420,796 describes an apparatus for light dissemination of light radiation which comes from a light conductor. The dissemination of the light radiation itself creates problems, as it often is desirable to keep the relatively small bunch of beams from the light conductor.

### SUMMARY OF INVENTION

One purpose of the present invention is to bring about an apparatus for capture and transfer of sunlight where heating of the end of the light conductor is reduced.

According to the invention it is provided an apparatus for capture and transfer of sunlight. The apparatus comprises a light capturing section, an optical fibre which comprises a first end, a second end and a light transferring section arranged between the ends, which light transferring section along its entire length has an essentially constant cross-sectional area and which first end is connected to the light capturing section, and a body with essentially the same refractive index as the light transferring section. The second end of the optical fibre is connected to a first end of the body, the second end of the body, which is opposite the first end of the body, has a larger cross-sectional area than the light transferring section and first and second ends of the body are essentially plane parallel.

The transparent body is designed so that the light beams which pass through it are not affected in their outwardly radiant angle, which is achieved by the first and second ends of the bodies being plane parallel. With such an apparatus it is free in later stages to affect the direction of the light with lenses or similar, or to keep the relatively small bunch of light for a collective light image.

The body can be cone shaped.

The side surface of the body can be provided with an internally reflecting material. This results in a larger part of the beams being led out through the body through the second end, instead of leaving the body through a side surface.

The body can be coloured. In this way a desired colour temperature of the outgoing light is received. For example an adjustment can be implemented in order to compensate for a colour shift which is caused by the light transferring section.

The body can be a glass body.

The second end can have a free anti-reflection treated surface.

The body can be attached to the light transferring section by means of glue, gel or similar.

The apparatus can further comprise an inner socket which cohesively covers a part of the light transferring section.

The inner socket can comprise material which is more heat conductive than the optical fibre.

The apparatus can further comprise an outer socket which cohesively covers a part of the light transferring section and at least part of the body.

The inner socket can be completely encased by the outer socket.

The outer socket can comprise material which is more heat conductive than the optical fibre.

The outer socket can have a surface augmented outer surface.

The outer surface augmented surface can at least partly be in the form of threads.

### BRIEF DESCRIPTION OF THE DRAWINGS

The invention is going to be more closely described as examples, with reference to enclosed drawings, wherein:

FIG. 1 is a schematic drawing of an optical fibre in an embodiment,

FIG. 2 is a schematic drawing of an optical fibre of FIG. 1 with connected transparent body,

FIG. 3 is a schematic drawing of the optical fibre in FIG. 2, with a surrounding socket,

FIG. 4 is a schematic drawing of an embodiment with improved heat emission,

FIG. 5 is a schematic drawing of an embodiment with an inner socket, and

FIG. 6a-c are schematic drawings of different embodiments of the inner socket.

### DESCRIPTION OF PREFERRED EMBODIMENTS

FIG. 1 is a schematic drawing of an optical fibre in an embodiment. An optical fibre 1 conducts light, e.g. sunlight. A light beam 5 is transmitted out from the optical fibre 1. Another light beam 6 is reflected back at the crossing between the core of the fibre and the exit towards air.

FIG. 2 is a schematic drawing of an optical fibre with connected body. Here the optical fibre 1, alternatively a bunch 1 of optical fibres, is provided with a protective coating 3. The light emitting end of the fibre 1 is attached to a transparent body 2, such as en glass body. A light beam 5 is in this way transferred through the fibre 1 and out through the body 2. As the optical fibre 1 ends without a transparent body, the part of the light which is reflected at the crossing of the light from the core of the fibre and air is reflected back into the fibre in order to finally beam back towards the light source, e.g. the sun.

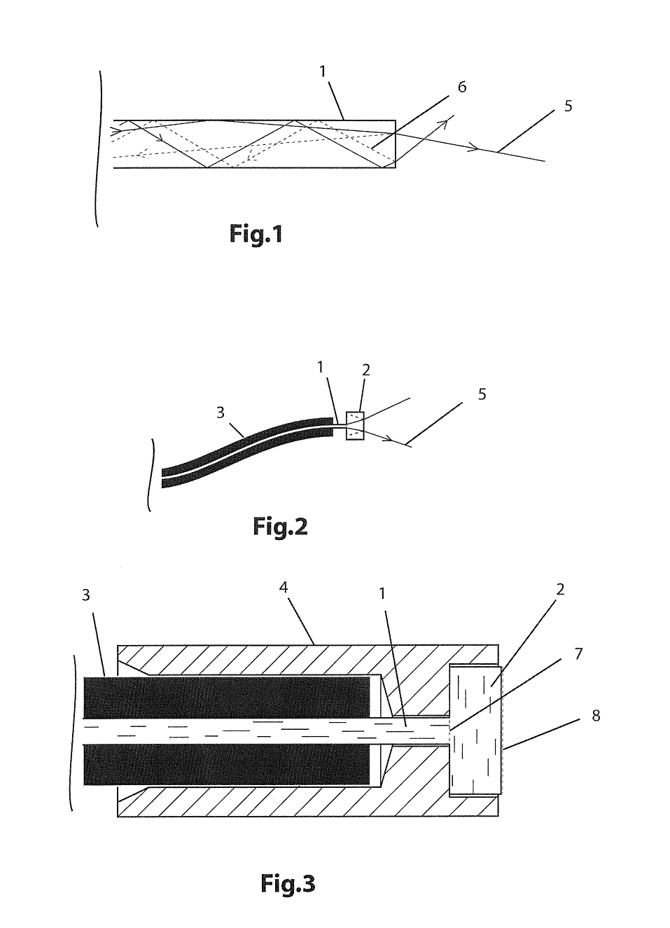

FIG. 3 is a schematic drawing of the optical fibre in FIG. 2, with a surrounding socket. The figure shows a preferred arrangement of optical fibre 1 with protective socket 3 which via a cohesive interlocking socket 4 keeps the fibre together with the transparent body 2. The area 7 where the optical fibre 1 and the transparent body 2 meet can be composed of glue alternatively some other substance with a refractive index preferably between the optical refractive index of the fibre and the transparent refractive index of the body in order to minimise reflections between surface layers. The body 2 is on the free surface 8 covered with an anti-reflection treatment in order to reduce the loss of transmission when the light beams leave the transparent body.

According to an apparatus which is an embodiment of the invention, the end of the fibre where the light passes out is designed with larger cross-sectional area than the other light transferring section of the fibre. This can according to the invention be accomplished with the body 2 which is mounted on the fibre 1 so that the beams diverge somewhat before they leave the glass. Thereby the amount of radiation per surface unit is reduced where the light beams leave the body 2, which reduces the risk for incineration of contaminants which can happen on the surface 8 of the body 2. If the surface 8 where the light leaves the body 2 is made of glass, cleaning, if any, is made easier. The body 2 is mounted opposite the core of the optical fibre so that no air is between the body 2 and the core 1 of the optical fibre. This can be done by gluing the glass with a transparent glue with a refractive index in the vicinity of the refractive index of the glass and the refractive index of the core of the optical fibre. Instead of glue, an optical transparent gel can be used or another substance. The body 2 has great resistance against any relevant stress. The body 2 protects the core of the fibre and cladding and any glue from the influence of the air. If the body is made of glass, then the glass conducts heat better than e.g. PMMA, which has the advantage of better deflecting heat which can have been generated by contaminants on the surface where light beams pass out into the air.

As a body 2 is mounted at the optical end of the fibre, only a very little amount of the light which is reflected at the transition of the light from the material of the body, e.g. glass, to air is reflected back into the optical fibre 1. Instead most of the reflected light is reflected within the transparent body in varying degree in order to some extent be converted to heat energy. This implies that the body 2 can be heated by a part of the reflected radiation energy.

The apparatus can due to the above comprise an anti-reflective treatment of the transparent body on the opposite surface 8 to which the optical fibre 1 is connected. The anti-reflective treatment reduces the transmission losses resulting from reflection. The transmission losses through reflection can be as much as four percent. This results in less light radiation being converted to heat at the transparent body. This also results in the sunlight collecting device having better efficiency when the transmission loss can be reduced to fractions of a percent.

The apparatus can also comprise a socket 4, e.g. made of metal, which holds together the optical fibre with the body 2 at the end of the fibre. The socket 4 then also functions as a heat conductor. The socket 4 is preferably designed so that it at the same time functions as a fastening device for connection of the optical end of the fibre to armature or similar.

The transparent body is designed so that the light beams which have passed through it are not affected in their radiating angle. This is achieved by the active surfaces being plane parallel. The surface through which the light passes into in the transparent body 5 is plane parallel with the surface through which the light leaves the transparent body 8.

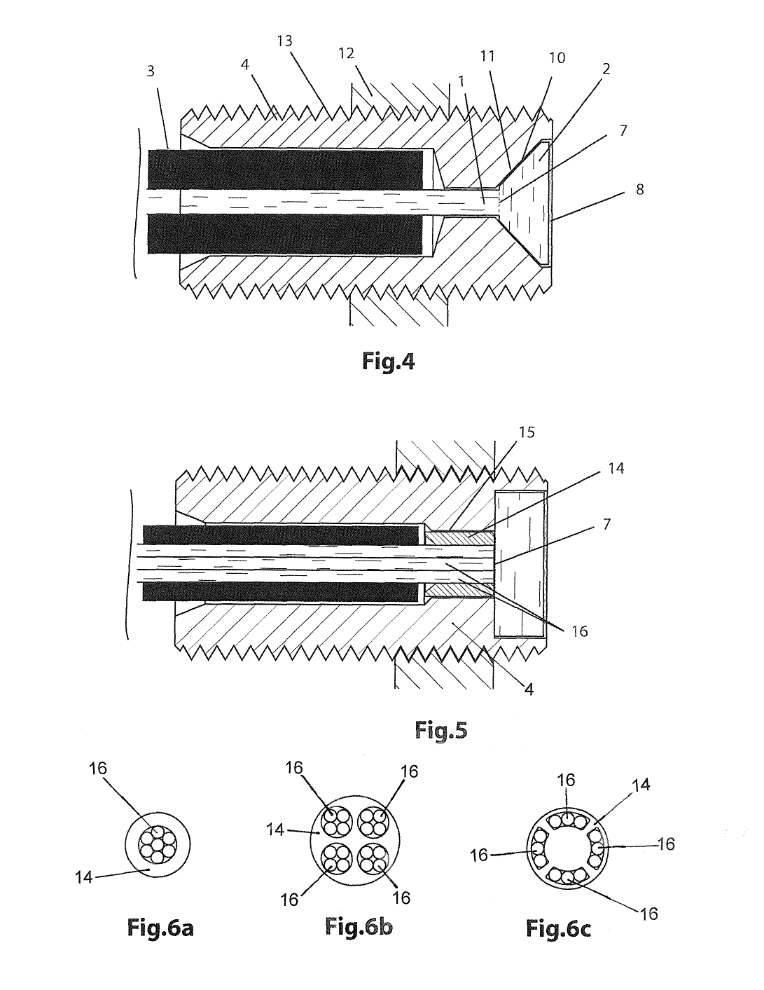

FIG. 4 is a schematic drawing of an embodiment with improved heat emission. Here the transparent body 2 is designed as a cone shaped rotational body so that it follows the light beams radiating from the optical fibres. The cone shaped surface 10 can be designed with an internally reflecting metallic surface, which makes a larger portion of the light beams, which internally reflect within the transparent body, leave the transparent body through the flat exit surface. By designing the transparent body 2 to be cone shaped according to the above, the heat transporting path is reduced towards surrounding socket 11 or sockets 14 which can be designed in material with larger heat conducting capacity.

The outer socket 4 holds together the optical fibre with the transparent body at the end of the fibre 1. The outer socket 4 and the transparent body 2 are preferably mutually designed so that good heat conduction between them can occur.

The outer socket 4 then also functions as a heat deflector and can be designed with surface augmented shape 13 toward surrounding air for heat deflection via convection and radiation and can even be designed so that heat deflection towards bearing surrounding structures 12 becomes good.

The design for the heat deflection toward air and toward surrounding structures can be in the form of a thread which encircles the outer socket.

FIG. 5 and FIG. 6a-c are schematic drawings of the embodiment with an inner socket 14. The inner socket 14 holds together the optical fibres 16 and is in turn mounted in an outer socket 4.

The inner socket 14 simplifies the production of the end closing when work tasks can be divided and finished before final assembly of the end closing. In the cases in which several optical fibres 16 gather in the same end closing, the inner socket makes it easier to divide them in multiple cavities or formations, such as is shown in FIG. 6a-c, in order to obtain larger heat deflecting surfaces towards the inner socket which can be composed of material with better heat conducting qualities than the optical fibres 16.

When the optical fibres 16 are spread, it is enabled to fill the cavities lying between the optical fibres 16 and between the optical fibres 16 and the inner socket 14 and/or outer socket 4 before they pass into the inner socket 14 or the outer socket 4 with heat conducting paste or similar. The heat conducting paste can be silicone.

The inner socket 14 and the outer socket 4 are assembled so that good heat conducting between them is achieved. The composition of the two sockets can be in the form of a thread or similar or/and in the form of glue or similar with good heat conduction abilities and good filling abilities.

The inner socket and the outer socket can both be in contact with the transparent body.

Now the colour aspect of the apparatus is going to be discussed. Different fibre qualities have different damping per unit of length through the frequency spectrum, whereby different fibre lengths affect what colour temperature is transmitted.

The transparent bodies 2 can be weakly coloured so that desired colour temperature of the radiant light can be maintained. The colouring of the transparent bodies 2 results in some heating by the light within the undesired frequencies which is filtered away. For this reason good heat deflection and good heat transfer between the transparent body and the outer socket is especially important.

The present invention such as described herein is naturally not limited to the embodiments described above and shown on the drawings, but rather can be modified within the framework for the enclosed claims.

1. An apparatus for capture and transfer of sunlight comprising:
a light capturing section,
an optical fiber which comprises a first end, a second end and a light transferring section arranged between the ends, which light transferring section along its entire length has an essentially constant cross-sectional area and which first end is connected to the light capturing section, and
a body with essentially the same refractive index as the light transferring section
characterised by
the second end of the optical fiber being connected to a first end of the body,
the second end of the body, which is opposite the first end of the body, has a larger cross-sectional area than the light transferring section and the first and second ends of the body are essentially plane parallel.

2. The apparatus according to claim 1, wherein the body is cone shaped.

3. The apparatus according to claim 1, wherein a side surface of the body is provided with an internally reflecting material.

4. The apparatus according to claim 1, wherein the body is colored.

5. The apparatus according to claim 1, wherein the body is a glass body.

6. The apparatus according to claim 1, wherein the second end has a free anti-reflection treated surface.

7. The apparatus according to claim 1, wherein the body is attached to the light transferring section by an attachment consisting of: a glue or a gel.

8. The apparatus according to claim 1, comprising an inner socket which cohesively covers a part of the light transferring section.

9. The apparatus according to claim 8, wherein the inner socket comprises material which is more heat conductive than the optical fiber.

10. The apparatus according to claim 1, comprising an outer socket which cohesively covers a part of the light transferring section and at least a part of the body.

11. The apparatus according to claim 7, comprising an outer socket which cohesively covers a part of the light transferring section and at least a part of the body wherein an inner socket is completely encased by the outer socket.

12. The apparatus according to claim 10, wherein the outer socket comprises material which is more heat conductive than the optical fiber.

13. The apparatus according to claim 12, wherein the outer socket has an area increasing outer surface.

14. The apparatus according to claim 13, wherein the outer area increasing surface is at least partly in a form of threads.

15. The apparatus according to claim 8, comprising an outer socket which cohesively covers a part of the light transferring section and at least a part of the body wherein the inner socket is completely encased by the outer socket.
